(19) United States
(12) Patent Application Publication
(10) Pub. No.: US 2013/0035146 A1
(43) Pub. Date: Feb. 7, 2013

(54) Computer-Based, Multiplayer Card Selection Game That Uses Card Selection Undo To Determine Scoring

(71) Applicant: Arthur M. Pfeiffer, Palo Alto, CA (US)

(72) Inventor: Arthur M. Pfeiffer, Palo Alto, CA (US)

(73) Assignee: THWARTPOKER INC., Palo Alto, CA (US)

(21) Appl. No.: 13/563,641

(22) Filed: Jul. 31, 2012

Related U.S. Application Data
(60) Provisional application No. 61/574,430, filed on Aug. 2, 2011.

(51) Int. Cl. A63F 13/00

(52) U.S. Cl. 463/11

(57) ABSTRACT

The present invention relates to a single actual player playing a multiplayer card selection game against a set of virtual players. It creates a new game that uses the card selection feature of inventor's previous games, but has a very different goal and structure than those games. Instead of the actual player trying to build the best hand with no guarantee of success, the actual player tries to use card selection undo followed by reselecting more optimal cards the fewest number of times to build the best hand playing against the virtual players. In addition, actual players can compete against each other to determine who is best at playing the same game against the same number of virtual players. The winner is the actual player who uses undo card selection the fewest number of times in building the best hand playing against his/her set of virtual opponents.

### CROSS-REFERENCE TO RELATED APPLICATIONS

This application is based on provisional application Ser. No. 61/574,430, filed on Aug. 2, 2011, entitled COMPUTER-BASED, MULTIPLAYER CARD SELECTION GAME THAT USES CARD SELECTION UNDO TO DETERMINE SCORING.

### TECHNICAL FIELD

The present invention relates to computerized, multiplayer, card selection games involving a single actual player playing against a set of virtual players and, in particular, to a game where the goal of the actual player is to obtain the best hand by undoing card selections and reselecting more optimal cards the fewest number of times compared to other actual players.

### BACKGROUND

Historically, the hundreds of different card games played around the world like poker have all been based on random dealing thru the use of shuffling. However, with the advent of computers, the present inventor, Arthur Pfeiffer, previously invented a new way of dealing cards in a multiplayer game where random dealing to individual players is replaced by player card selection. With this method, on at least one round, each player first privately selects a desired card from the same face up deck of playing cards. Once every player has selected a card, the game management system then determines what card each player is dealt. A player whose selection is in conflict with that of another player is dealt a null card that has no value. Otherwise, the player is dealt the card he/she selected.

U.S. Pat. No. 4,662,637 to Arthur Pfeiffer discloses a method of playing a card game in which the players select desired cards from a deck of playing cards, which are delivered to players unless a player requests the same card that another player has requested during the same round of play or was dealt on a previous round, in which case a null card, having no value in determining the outcome of the game, is delivered to the requesting player. Poker scoring rules are used to determine the outcome of the game.

U.S. Pat. No. 4,667,959 to A. Pfeiffer discloses a selector unit and card-storage carousel for playing a card game disclosed in U.S. Pat. No. 4,662,637.

Many games are now played on computing devices and the concept of playing card games over a network such as the Internet is well known. Patents have been granted to new card games that include claims that cover playing the game over the Internet. For instance, U.S. Pat. No. 5,951,012 discloses a poker game where the amount of successive wagers is pre-established by the players; this game may be played on the Internet. Similarly, U.S. Pat. No. 6,012,720 discloses, “enhanced features” of the card game Double Hand; this game may also be played on the Internet.

U.S. Pat. No. 6,679,777 B2 and related reissue U.S. Pat. No. RE41,331 E to Arthur Pfeiffer, both incorporated herein by reference, disclose a method of playing network-based multiplayer card selection games on computing devices that can communicate with each other on the Internet, over a local area network, or by other means such as Bluetooth or Wi-Fi. These games follow the scoring rules of poker and can involve both actual and virtual players. When one actual player plays against a set of virtual players, a single computing device can be used that also contains the server software for network communication. On each round each player first privately selects a card from the same deck of playing cards. In one embodiment, on the same computing device, after each player has made his/her card selection, a player is dealt a null card that has no value, if that player's selected card is the same as a card selected by another player on the same or previous round. Otherwise, that player is dealt his/her selected card. In another embodiment, on the same computing device, after each player has privately made his/her card selection, that player is dealt a null card that has no value if that player's selected card is the same as a card selected by another player on the same round or was dealt to a player on a previous round. Otherwise, that player is dealt his/her selected card.

U.S. Pat. No. 7,717,783 B2 to Arthur Pfeiffer, incorporated herein by reference, discloses a method of playing multiplayer card selection games on one or more computing devices that follow the scoring rules of poker or, more generally, that follow predetermined rules of play, and can involve both actual and virtual players. These games use a mixture of community cards and cards selected by the players. The community cards are randomly dealt first from a deck of playing cards. All the players share the same community cards. After the community cards are dealt there are one or more rounds where each player privately selects a desired card from the same deck of playing cards face up. After all the players have made their card selection in a round, each player is dealt a card following the rules described in reissue U.S. Pat. No. RE41,331 E.

U.S. Pat. No. 7,806,408 B2 to Arthur Pfeiffer, incorporated herein by reference, discloses a computerized table with display screens for playing a card selection game between real players disclosed in U.S. Pat. No. 7,717,783 B2. The table system may contain electronic sensors for sensing the identity of an actual card or the value of chip, in which case actual cards and/or betting chips containing radio frequency identification (RFID) chips can be used.

U.S. patent application Ser. No. 12/731,119 to Arthur Pfeiffer, incorporated herein by reference, discloses a method of playing computerized multiplayer card selection games that follow the scoring rules of poker or, more generally, that follow predetermined rules of play, in which a fixed deck of playing cards is used first either for randomly dealt community cards that are shared by all the players, or for one or more rounds where players select cards. Then a second deck of playing cards is generated that has fewer cards than the first deck and is composed of cards randomly selected from the first deck of playing cards. If community cards are used, the number of community cards plus the number of cards in the second deck of playing cards excluding any community cards is less than the number of cards in the fixed first deck of playing cards. There are then one or more rounds where each player privately selects a desired card from the second deck of playing cards, excluding community cards. After all the players have made their card selection in a round, each player is dealt a card following the rules described in reissue U.S. Pat. No. RE41,331 E.

The above-described patents and patent application by the present inventor each have claims regarding a single actual player playing a card selection game against a set of virtual players, where, in a round where players select their cards, each player first privately selects a card from the same deck of playing cards face up, and after every player has selected a card, each player is either dealt a null card when his/her selection is in conflict with that of another player, or otherwise is dealt his/her selected card. The goal and purpose of such games is for the actual player to try to win by building the best hand of all the players, according to predetermined rules of play. There may be situations where more than one player has the best hand. However, none of these games guarantee that the actual player will build the best hand and be the winner, for that defeats the purpose of the games themselves. In fact, in general, none of the above-described games by the present inventor provide the guarantee that a particular player, actual or virtual, will build the best hand.

### SUMMARY

The present invention relates to card selection games of the type described above involving a single actual player playing against one or more virtual players. However, it modifies the structure of the above-described games by the present inventor to create a new game where the goal of the actual player is to use a “card selection undo” button the fewest number of times in order to build the best hand, according to predetermined rules of play. In the present invention the actual player must get the best hand, and in doing so tries to minimize the number of times he/she uses card selection undo.

The use of card selection undo has no meaning in a standard multiplayer card game, for in those games there is no card selection, certainly not as described in the present inventor's pending patent or granted patents referenced above. Also, since cards in standard multiplayer card games are randomly dealt, even if undo were introduced into those games, there is no way to control the cards dealt to the different players to insure that any particular player will get the best hand. Some standard multiplayer card games like draw poker provide players with a chance to improve their hand by discarding some of their cards. However, the replacements are also randomly dealt, so the above analysis also applies to their use. Furthermore, the purpose of these standard multiplayer card games, even when involving a single actual player playing against a set of virtual players, is for the actual player to try to get the best hand without any way of being assured that he/she will succeed in getting the best hand.

The present invention relates to a single actual player playing a multiplayer card selection game against a set of virtual players. It creates a new game that uses the card selection feature of inventor's previous games, but has a very different goal and structure than those games. Instead of the actual player trying to build the best hand with no guarantee of success, the actual player tries to use card selection undo the fewest number of times possible in order to build the best hand playing against the virtual players. The new embodiments offer substantial improvements over the games disclosed by the inventor in U.S. Pat. No. 4,662,637, U.S. Pat. No. 4,667,959, U.S. Pat. No. 6,679,777 B2, U.S. Pat. No. RE41,331 E, U.S. Pat. No. 7,717,783 B2 and U.S. patent application Ser. No. 12/731,119, all incorporated herein by reference.

### BRIEF DESCRIPTION OF THE DRAWINGS

FIG. 1A shows a first actual player's screen in a 3-player game after 3 community cards have been randomly dealt and on the first card selection round, a possible card choice by the first actual player has been indicated but not confirmed.

FIG. 1B shows the first actual player's screen, for the same game as FIG. 1A, on the second card selection round, when a possible card choice by the first actual player has been indicated but not confirmed.

FIG. 1C shows the first actual player's screen, for the same game as FIG. 1A, at the start of the fourth card selection round when the actual player has elected to undo the previous third card selection round for all the players.

FIG. 1D shows the first actual player's screen, for the same game as FIG. 1A, at the start of the third card selection round, after the actual player in the fourth card selection round elected to undo the third card selection round.

FIG. 1E shows the first actual player's screen, for the same game as FIG. 1A, at the start of the second card selection round, after the actual player in the third card selection round elected to undo the second card selection round.

FIG. 1F shows the first actual player's screen, for the same game as FIG. 1A, on the third card selection round, when a card choice by the first actual player has been indicated and confirmed.

FIG. 1G shows the first actual player's screen, for the same game as FIG. 1A, on the fourth card selection round, when a card choice has been indicated and confirmed.

FIG. 1H shows the first actual player's screen, for the same game as FIG. 1A, again at the start of the fourth card selection round after the actual player's previous fourth card selection resulted in the actual player not having the best hand forcing an automatic card selection undo.

FIG. 1I shows the first actual player's screen, for the same game as FIG. 1A, when the game is over, for the first actual player built the best hand playing against 2 virtual players with card selection undo used three times.

FIG. 1J shows a second actual player's screen, for the same game as FIG. 1A, after the same 3 community cards used by the first actual player were randomly dealt, and on the first card selection round, a card choice by the second actual player has been indicated and confirmed.

FIG. 1K shows a second actual player's screen, for the same game as FIG. 1J, at start of the third card selection round when the actual player has elected to undo the previous second card selection round for all the players.

FIG. 1L shows the second actual player's screen, for the same game as FIG. 1J, on the first card selection round after the second actual player previously elected card selection undo twice. A card choice by the second actual player has been indicated and confirmed.

FIG. 1M shows the second actual player's screen, for the same game as FIG. 1J, when the game is over, for the second actual player built the best hand playing against 2 virtual players with card selection undo used two times.

FIG. 1N shows the first actual player's screen, for the tournament game against the second actual player, after the first actual player lost.

FIG. 1O shows the second actual player's screen, for the tournament game against the first actual player, after the second actual player won.

FIG. 2A shows an actual player's screen in a 2-player game and on the first card selection round, a possible card choice by the actual player from a larger first deck of playing cards has been indicated but not confirmed.

FIG. 2B shows the actual player's screen, for the same game as FIG. 2A, on the second card selection round, which is the first card selection round players select cards from a smaller second deck whose cards have been randomly selected from the first deck.

FIG. 2C shows the actual player's screen, for the same game as FIG. 2A, on the fifth card selection round, when a card choice by the actual player has been indicated and confirmed.

FIG. 2D shows the actual player's screen, for the same game as FIG. 2A, on the sixth card selection round, when a possible card choice by the actual player has been indicated and confirmed.

FIG. 2E shows the actual player's screen, for the same game as FIG. 2A, again at the start of the sixth card selection round after the actual player's previous sixth card selection resulted in the actual player not having the best hand, forcing an automatic card selection undo.

FIG. 2F shows the actual player's screen, for the same game as FIG. 2A, when the game is over, for the actual player built the best hand playing against one virtual player and used card selection undo one time.

FIG. 3A shows an actual player's screen in a 2-player game and on the first card selection round, a possible card choice by the actual player from a deck of playing cards has been indicated but not confirmed.

FIG. 3B shows the actual player's screen, for the same game as FIG. 3A, on the fifth card selection round, when a possible card choice by the actual player has been indicated and confirmed.

FIG. 3C shows the actual player's screen, for the same game as FIG. 3A, on the sixth card selection round, when a card choice by the actual player has been indicated and confirmed.

FIG. 3D shows the actual player's screen, for the same game as FIG. 3A, again at the start of the sixth card selection round after the actual player's previous sixth card selection resulted in the actual player not having the best hand, forcing an automatic card selection undo.

FIG. 3E shows the actual player's screen, for the same game as FIG. 3A, at the start of the fifth card selection round after the actual player in the sixth card selection round elected to undo the fifth card selection round.

FIG. 3F shows the actual player's screen, for the same game as FIG. 3A, again at the start of the sixth card selection round, when a card choice by the actual player has been indicated and confirmed.

FIG. 3G shows the actual player's screen, for the same game as FIG. 3A, when the game is over, for the actual player built the best hand playing against one virtual player and used card selection undo two times.

### DETAILED DESCRIPTION OF THE INVENTION

The present invention relates to card selection games where a single actual player plays against one or more virtual players. It modifies the structure of the above-described games by the present inventor to create a new game where the goal of the actual player is to use card selection undo the fewest number of times in order to build the best hand compared to those of the virtual players, according to the scoring rules of poker, or more generally, according to predetermined rules of play. In the present invention the actual player must build the best hand, and in doing so tries to minimize the number of times he/she uses card selection undo.

In the embodiments of the present invention described herein, after a round of player card selection has been completed and each player has either been dealt his/her card selection or a null card, whichever is appropriate, the actual player has the option to undo his/her card selection for the completed round. If the actual player chooses this option, then play reverts to the start of the card selection round just completed, with each player's previous selection and associated dealt card cancelled. Each player then gets to make his/her card selection anew for the old previously completed round, which is now the current card selection round. Furthermore, if the new current card selection round was preceded by a completed card selection round, the actual player has the option to undo that round and revert to its start. The actual player can repeat this process until there is no previously completed card selection round. Also, if the actual player does not have the best hand after each player has been dealt the predetermined number of card selection round cards for the game to be over, play then continues and reverts to the start of the card selection round just completed. In addition, the last card dealt to each player is not necessarily revealed to any player when the actual player does not have the best hand after the predetermined number of card selection rounds has been completed.

In one embodiment of the invention the games follow the scoring rules of poker. In another embodiment the games follow predetermined rules of play.

In one embodiment of the invention, after all players have privately selected a card in a card selection round, a null card, which has no value in determining the outcome of the game, is delivered to players who request the same card as another player has requested on the current round or a previous round. Otherwise, a player is dealt his/her selected card. In another embodiment, after all players have selected a card in a card selection round, a null card is delivered to players who request the same card as another player has requested on the current round or has been dealt to a player on a previous round. Otherwise, a player is dealt his/her selected card.

One embodiment of the invention has one or more community cards randomly dealt from a deck of playing cards, usable by any player in building a hand, according to predetermined rules and followed by one or more rounds of player card selection from the same deck of playing cards. Another embodiment only has one or more rounds of player card selection from a deck of playing cards. Another embodiment has one or more rounds of cards randomly dealt to each player from a deck of playing cards followed by one or more rounds of player card selection from the same deck of playing cards.

One embodiment of the invention has one or more community cards randomly dealt from a first deck of playing cards, usable by any player in building a hand, according to predetermined rules. Then a second deck of cards is generated that is composed of cards randomly selected from the first deck of playing cards excluding the community cards, where the number of cards in the second deck plus the number of community cards is less than the number of cards in the first deck. One or more rounds of player card selection from the second deck of cards then follow. Another embodiment has one or more community cards randomly dealt from a first deck of playing cards, usable by any player in building a hand, according to predetermined rules. Then a second deck of cards is generated that is composed of the community cards plus other cards randomly selected from the first deck of playing cards, where the number of cards in the second deck is less than the number of cards in the first deck. One or more rounds of player card selection from the second deck of cards then follow.

One embodiment of the invention has one or more rounds of player card selection from a first deck of playing cards. Then a second deck of cards is generated that has fewer cards than the first deck and is composed of cards randomly selected from the first deck plus any cards selected by the players from the first deck of playing cards. Then there are one or more rounds of player card selection from the second deck of cards.

One embodiment of the invention has a single actual player playing against one or more virtual players on the same computing device. Another embodiment has two or more actual players competing in a tournament, each with a computing device and each playing the same game against the same number of virtual players on his/her computing device. For each game having community cards, the same community cards are used on each computing device. Also, each game uses the same deck of playing cards for player card selection on each computing device and each game has the same number of card selection rounds on each computing device. In this embodiment the actual player that uses card selection undo the fewest number of times in building the best hand playing against his/her respective virtual players on his/her computing device is declared the tournament winner.

Several different operating environments are suitable for playing the game when more than one actual player is involved. The game can be played over the Internet or over a local area network. Using handheld computing devices like smartphones, such as the iPhone, the game can be played using Bluetooth or Wi-Fi for communication. In general, any operating environment that accommodates communication between computing devices or involves display terminals linked to a central computing device over a network can be used to play this invention.

In one embodiment of the invention two or more actual players, each using a separate computing device, play the same game against the same number of virtual players on his/her computing device. Game management software directs and facilitates play, controls the virtual players and keeps track of the number of times and when each actual player elects card selection undo. The game management software maintains a level playing field for the actual players. It insures that when each card selection and each use of card selection undo for 2 or more actual players is sequentially identical, then all the card selections for each set of their corresponding virtual players are also sequentially identical. The game management software also insures that when community cards are dealt in a hand, they are the same for all players. It also insures that each player uses the same deck of playing cards for card selection and that each player plays the same number of predetermined card selection rounds for the game to be over.

The embodiments in inventor's referenced patents or patent application that involve one actual player playing against one or more virtual players also constitute other embodiments of the current invention.

For all of the embodiments of the invention, the computing device used by an actual player has a display screen. Depending upon the type of display screen and computing device, when required, an actual player can point to and select on the display screen a desired card from the card selection deck. This is accomplished by means of a touch screen or keyboard, or when a cursor is involved, by means of a mouse, trackball or some other similar selection device.

The various described or referenced embodiments may be combined within one game. For instance, prior to any card selection rounds, there can be at least one community card dealt and at least one round where each player receives a randomly dealt card.

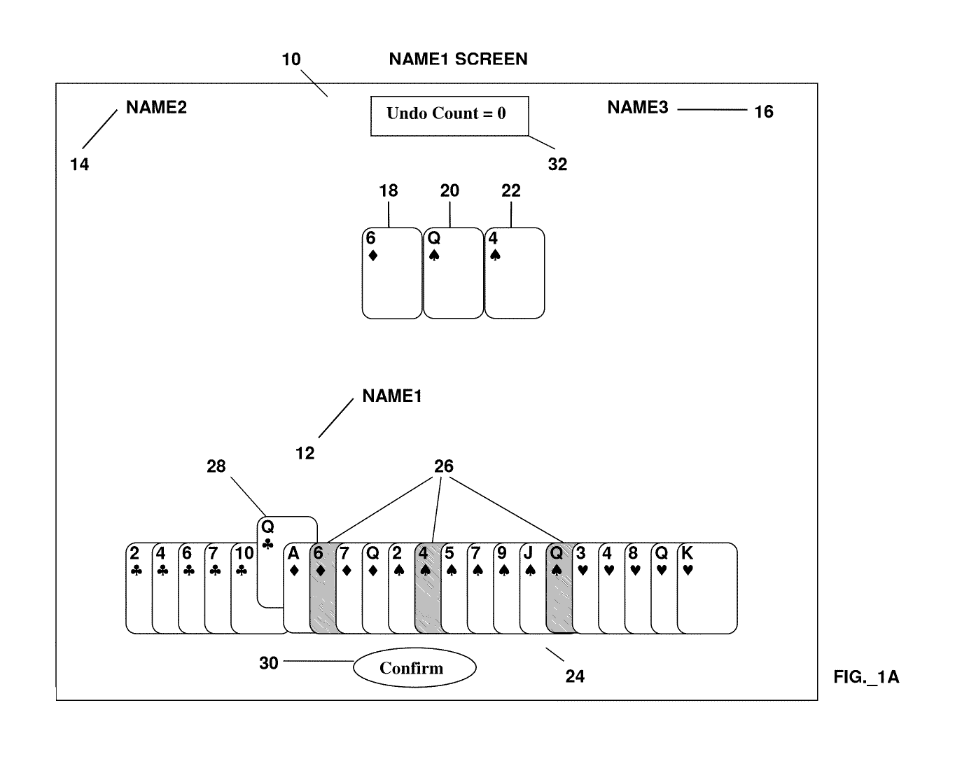

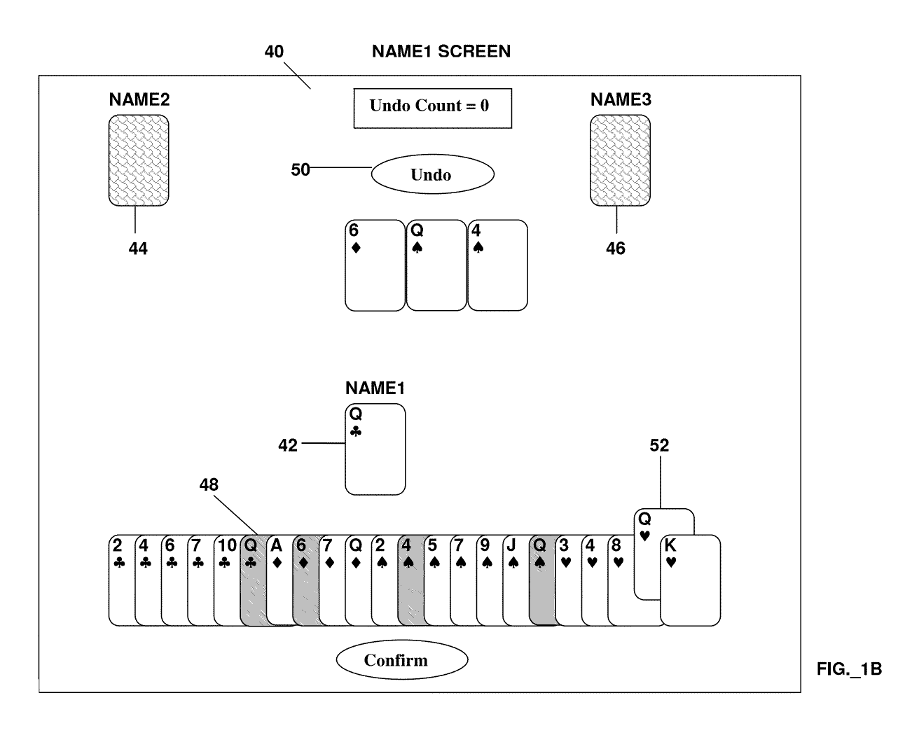

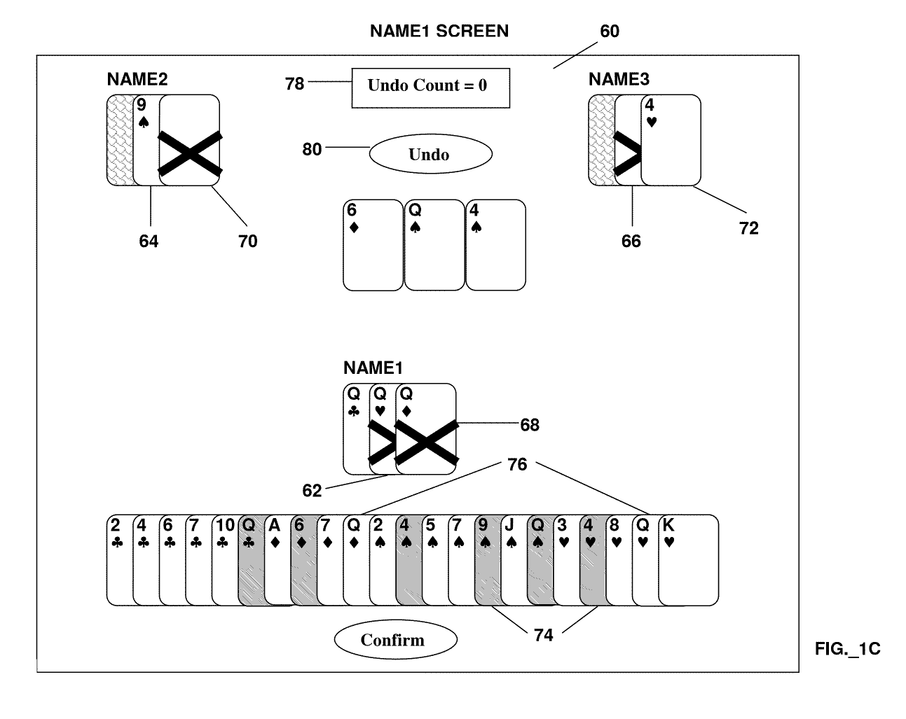

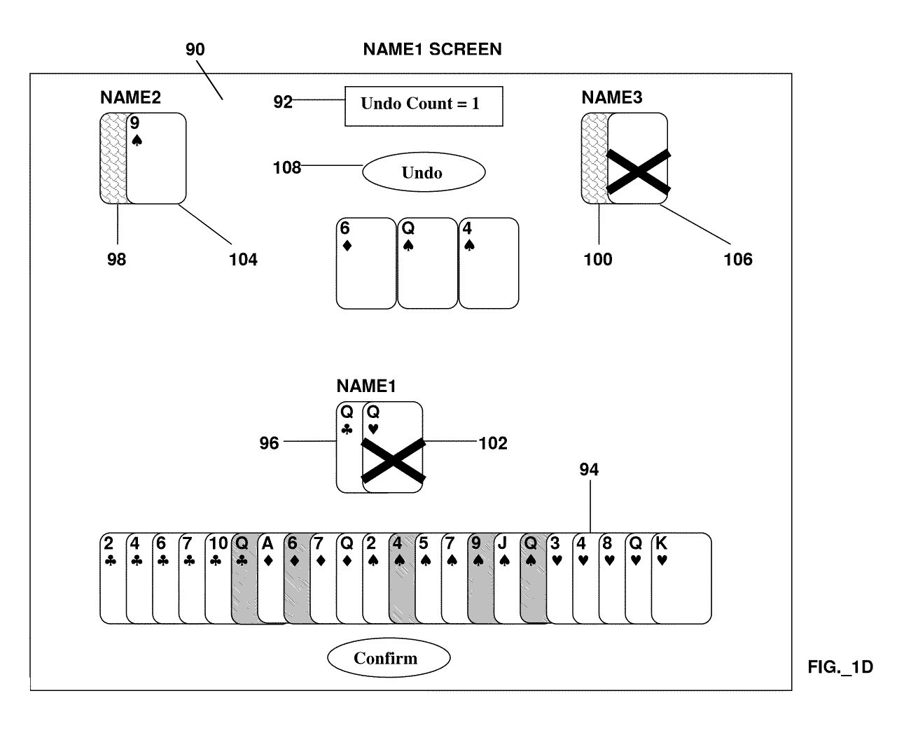

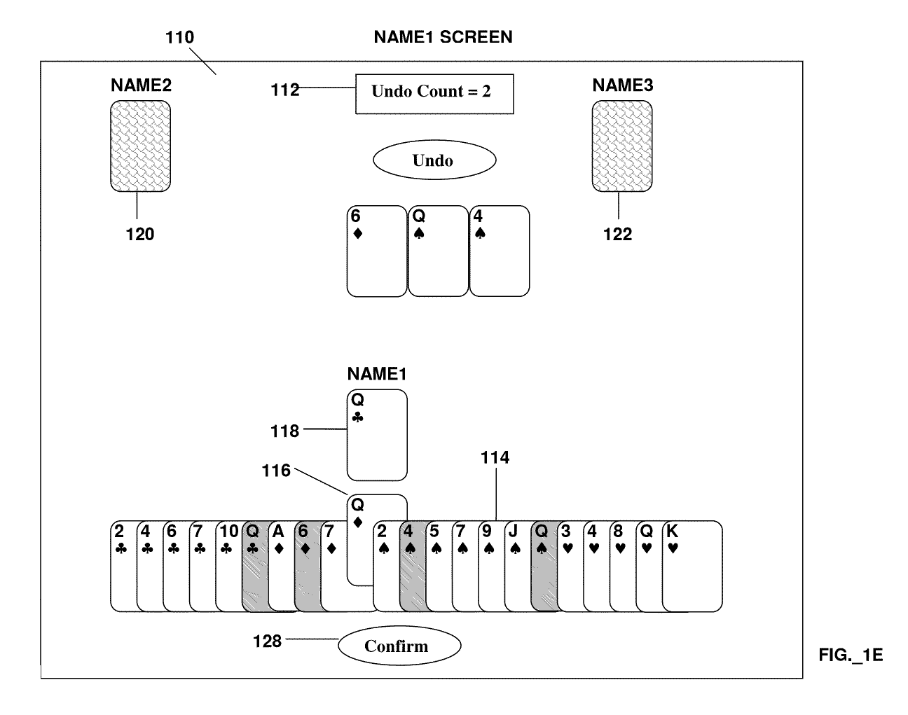

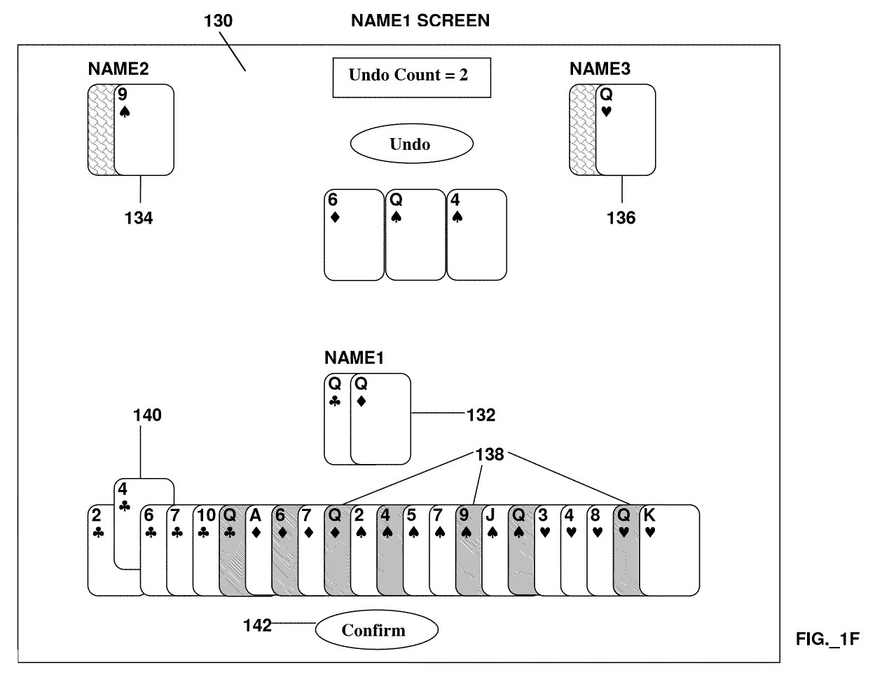

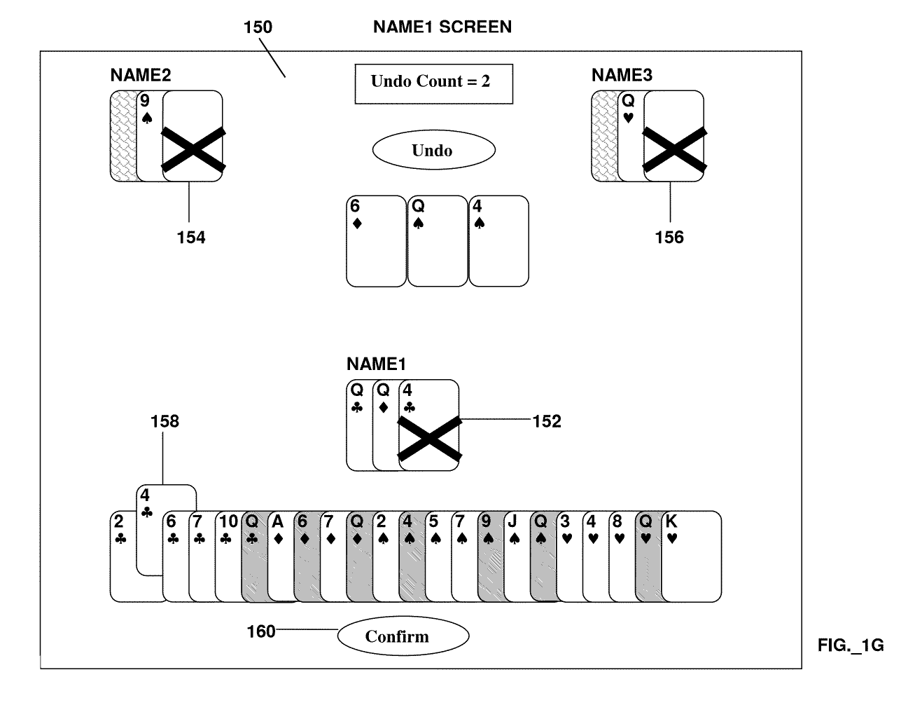

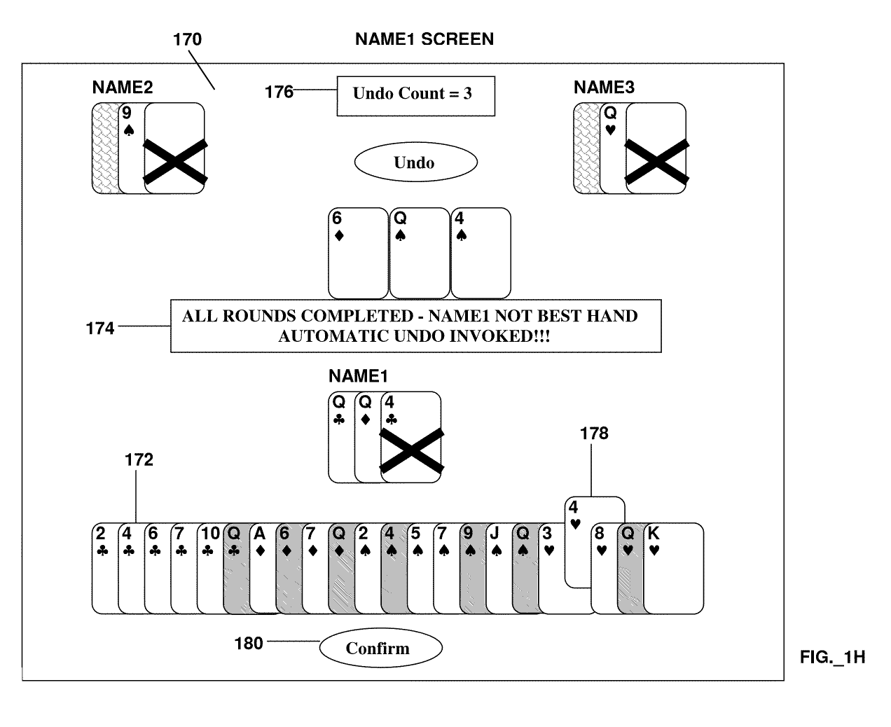

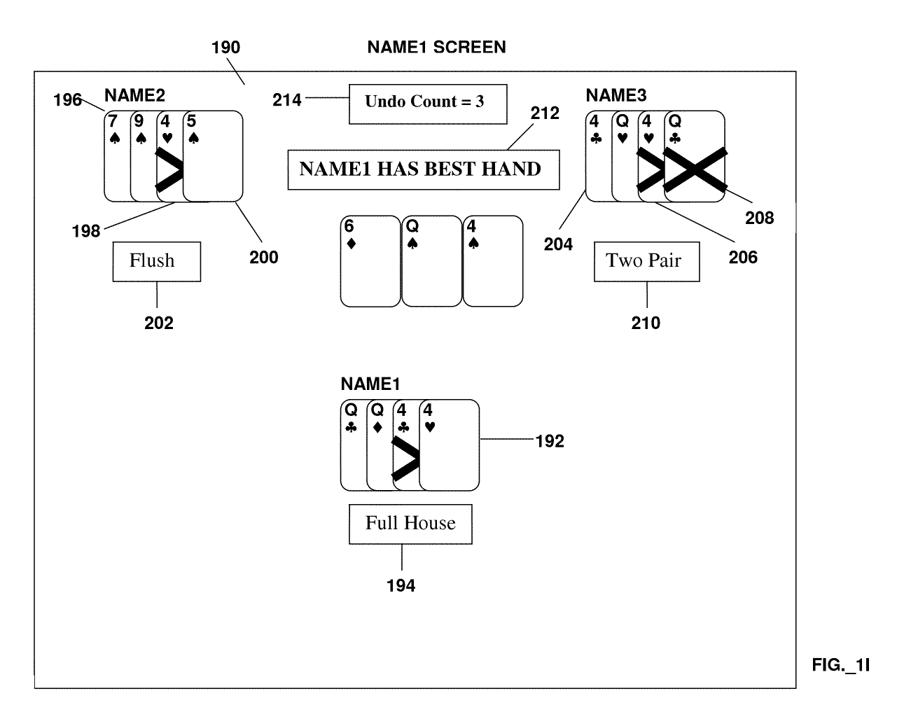

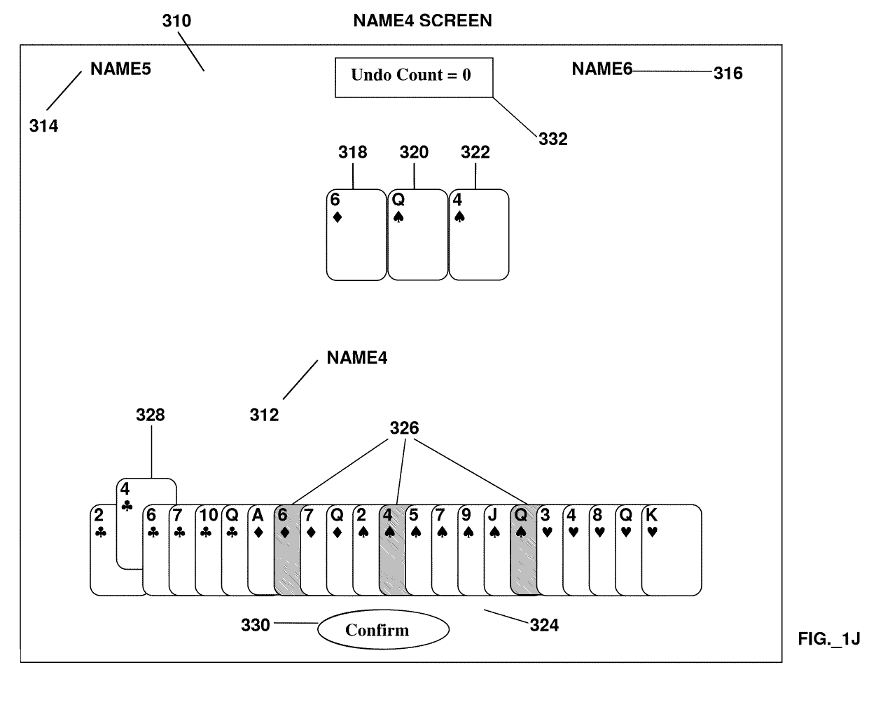

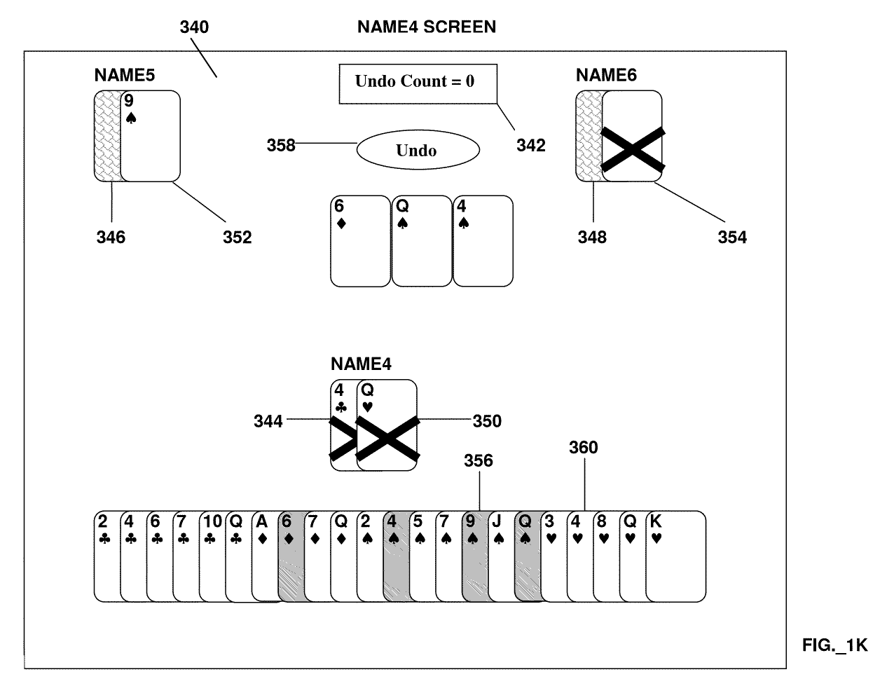

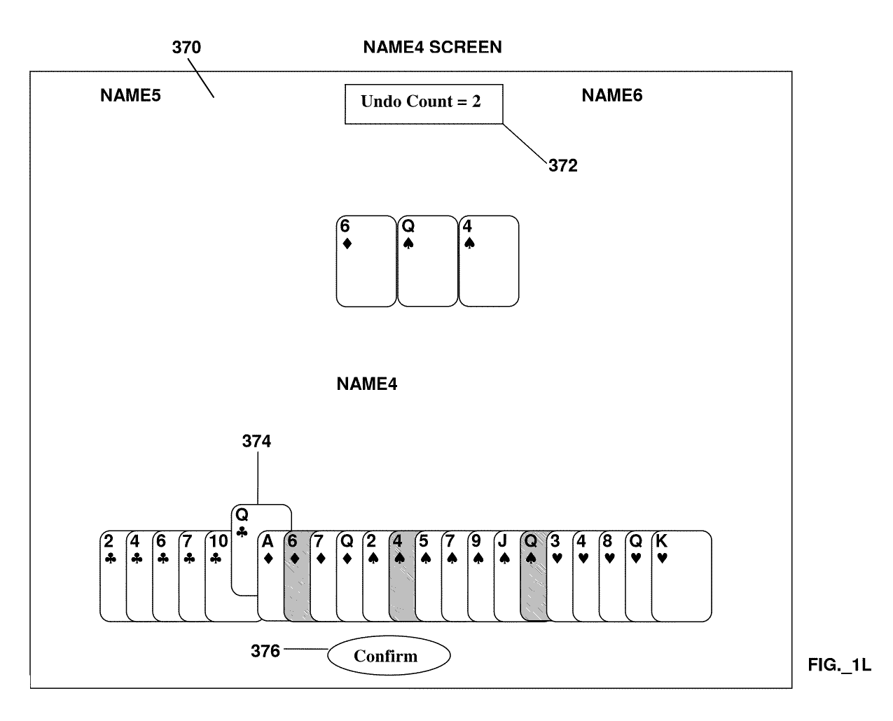

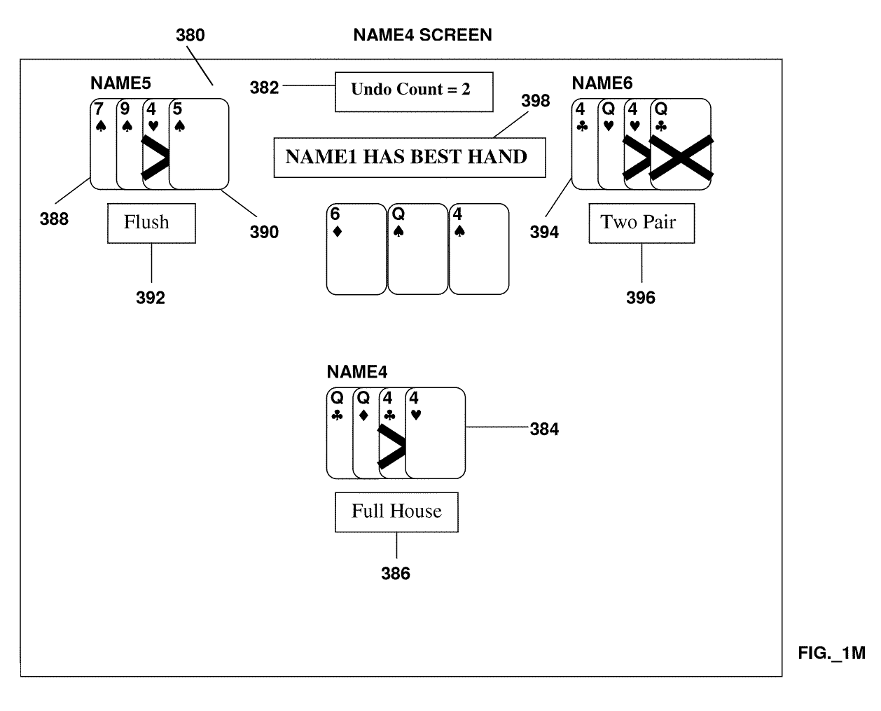

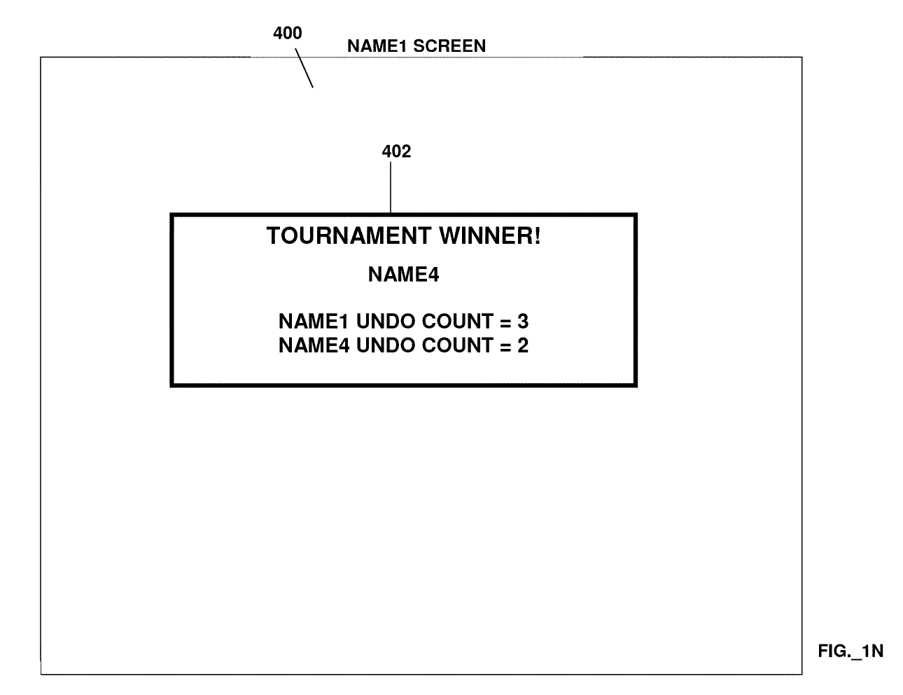

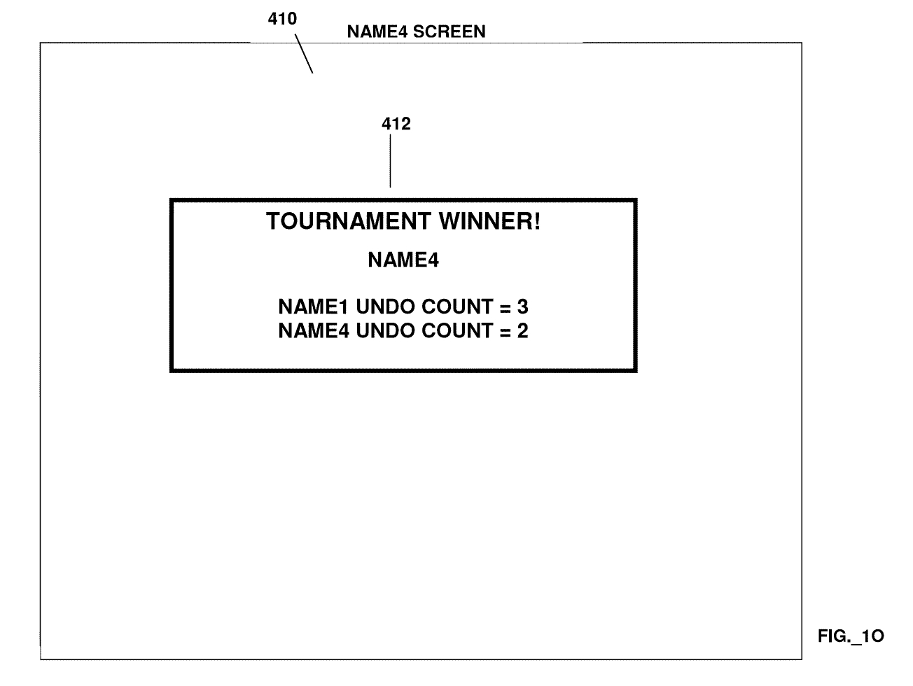

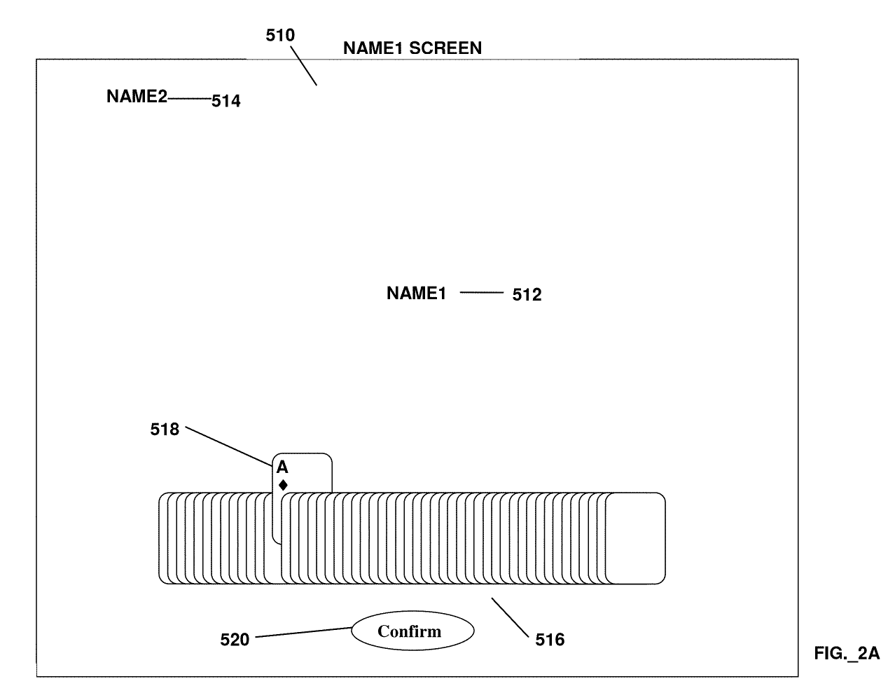

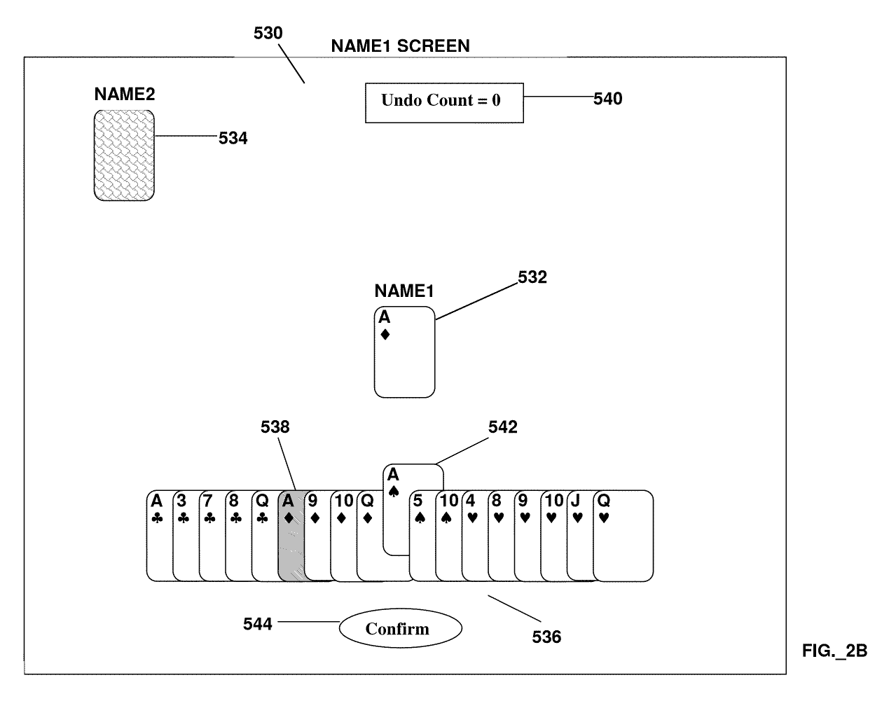

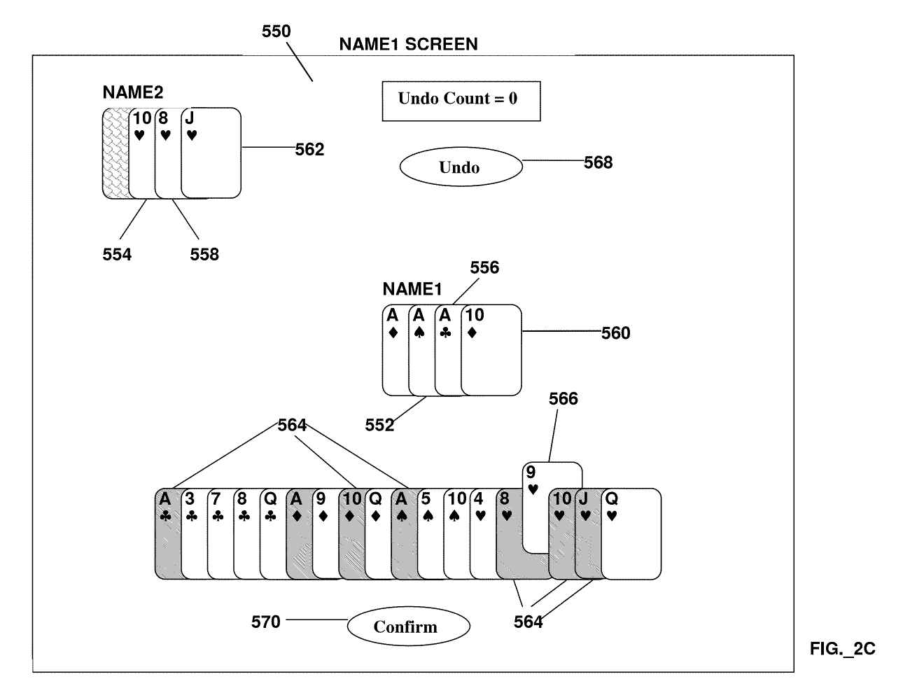

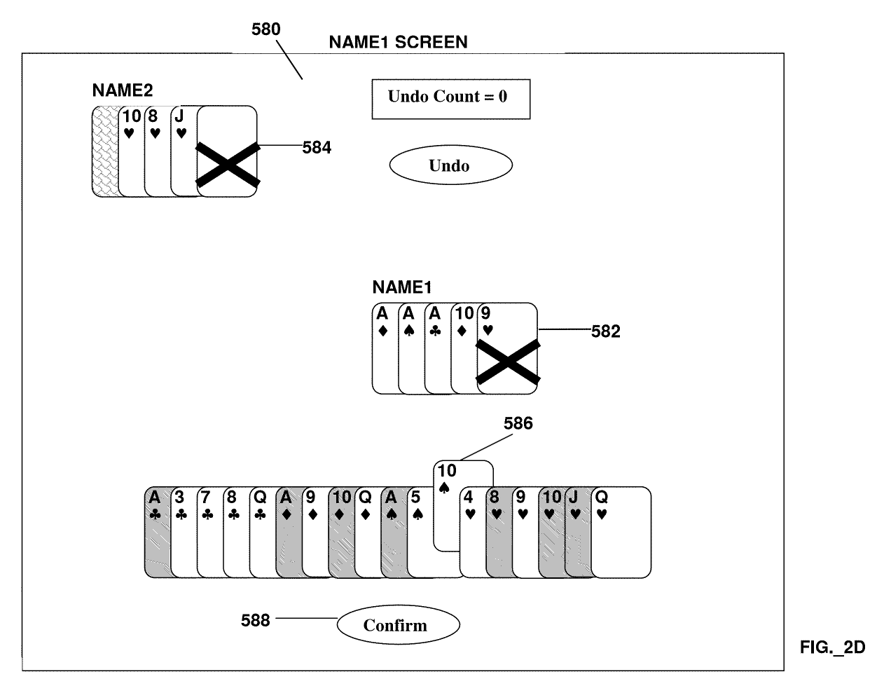

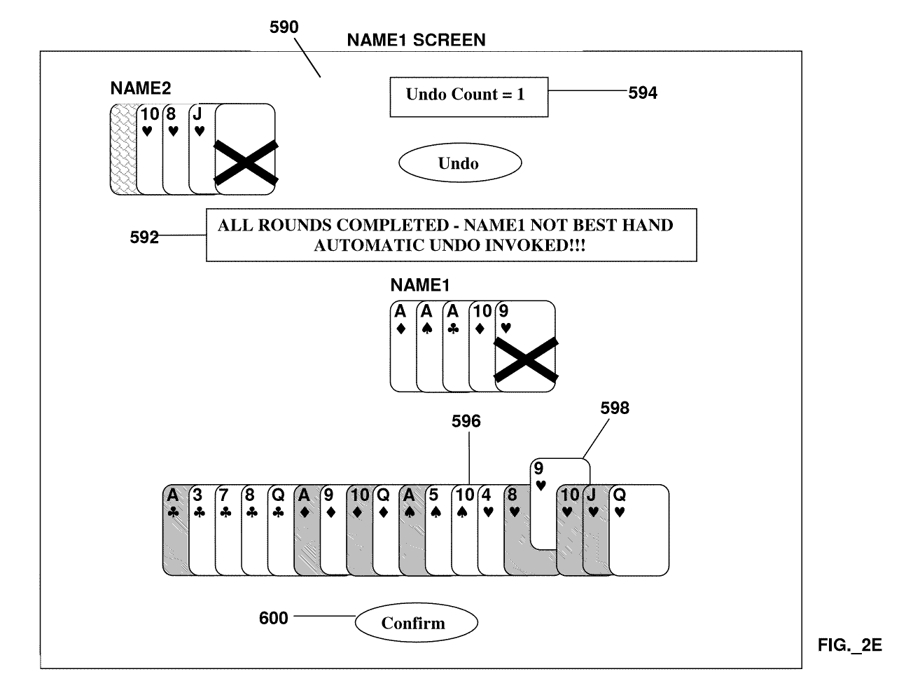

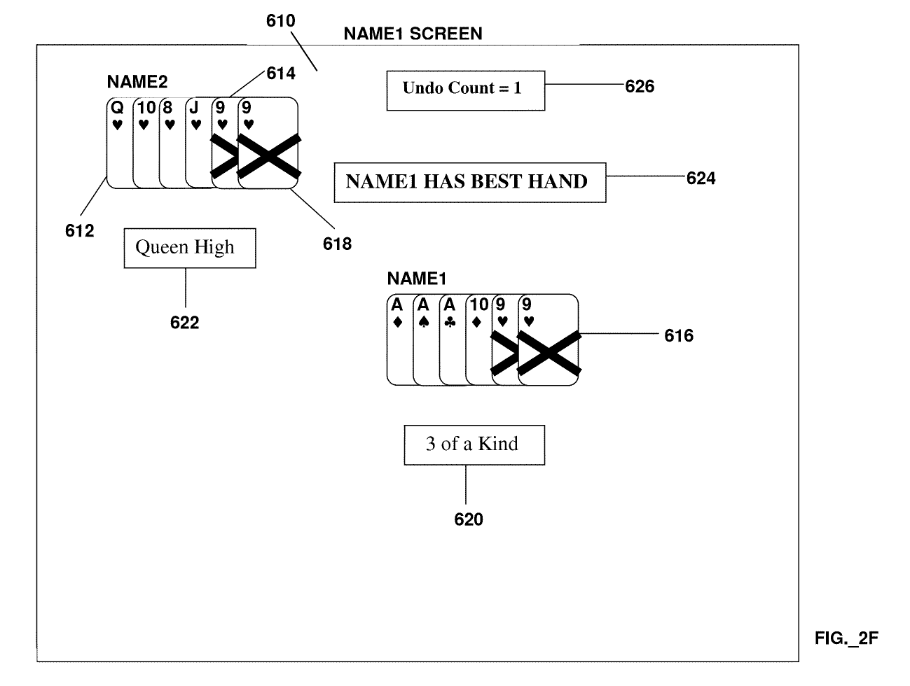

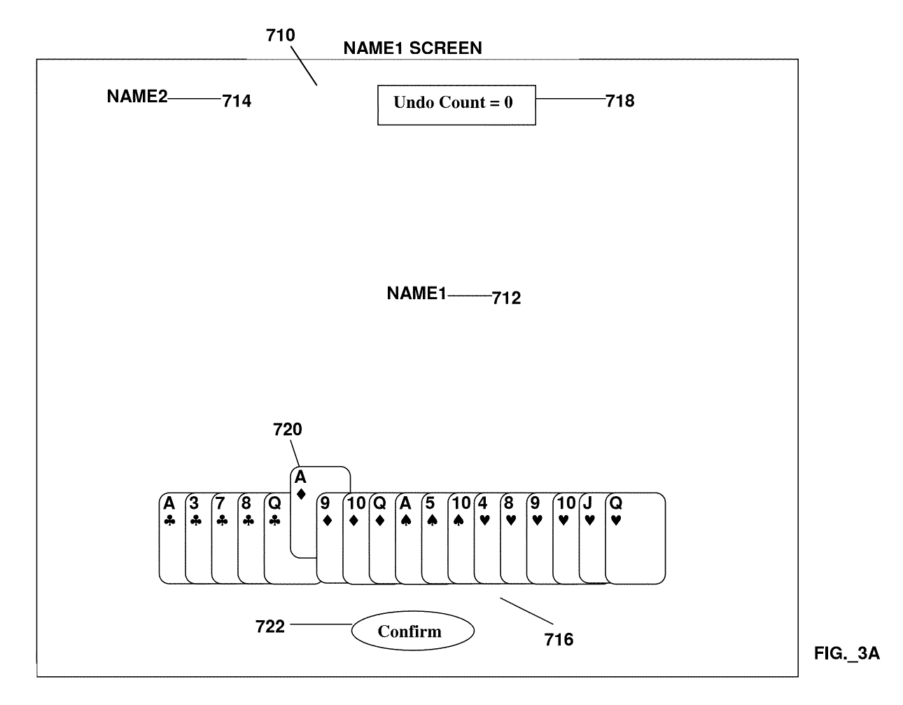

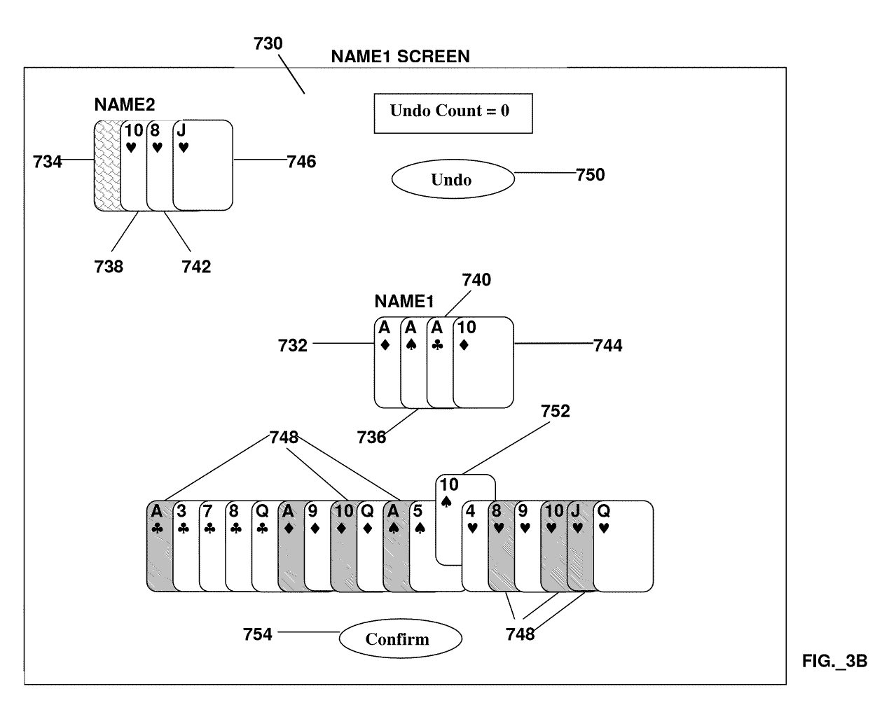

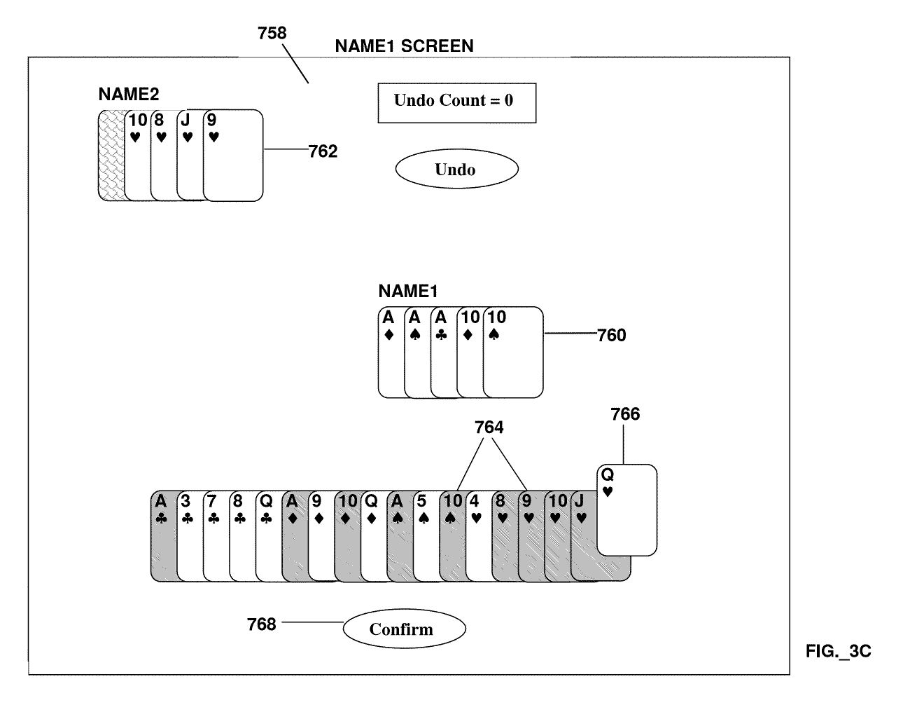

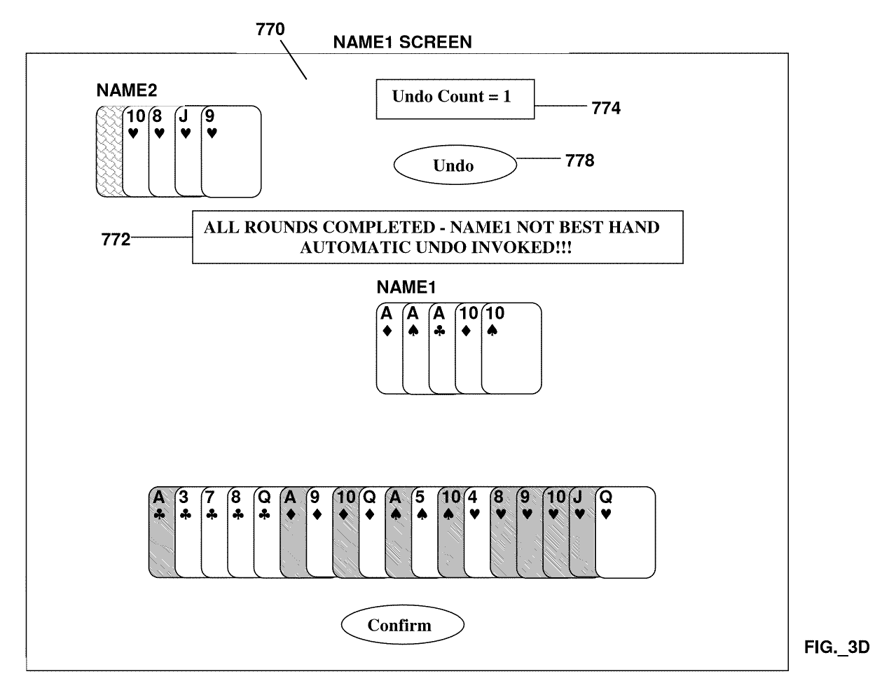

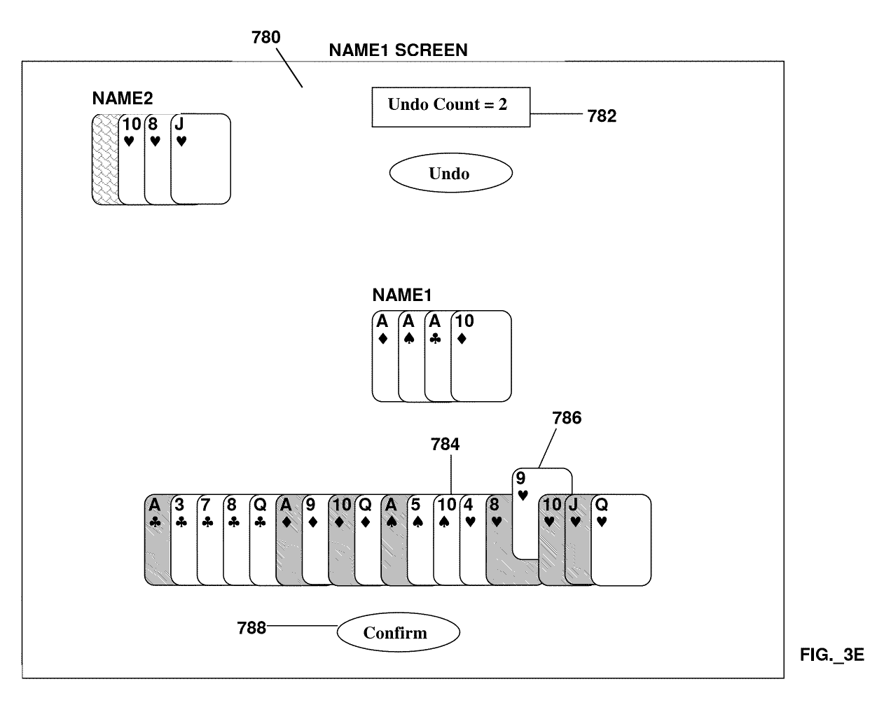

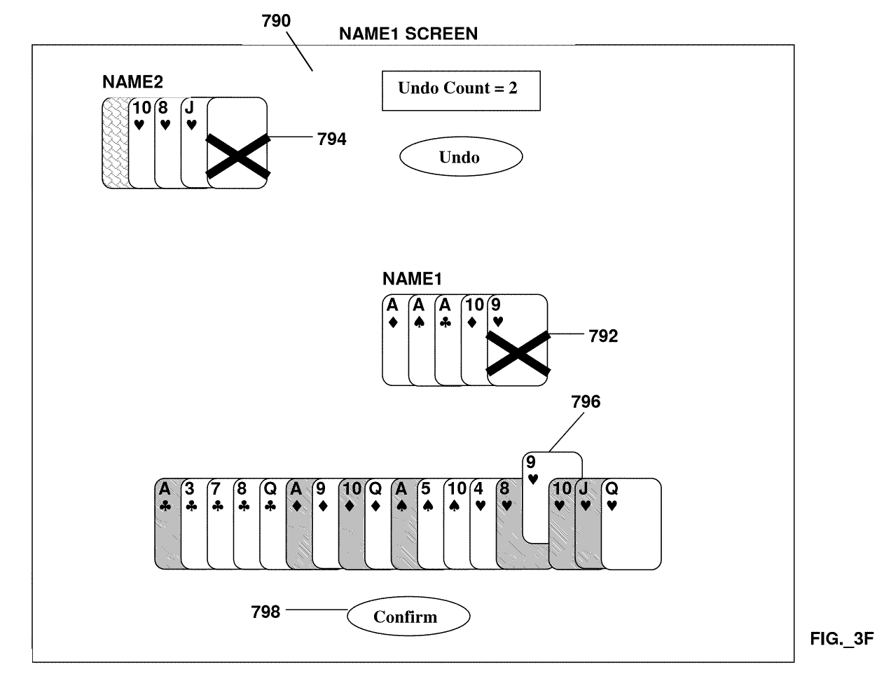

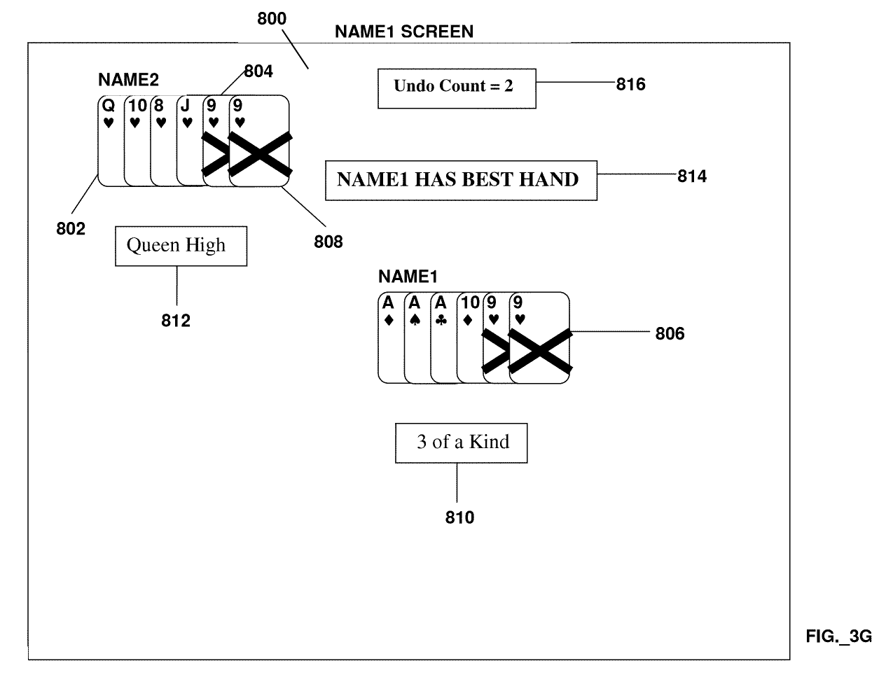

Twenty-eight screen drawings are included (FIGS. 1A-O, FIGS. 2A-F, FIGS. 3A-G) that all show the display screen of an actual player playing directly against a set of virtual players on the same computing device with a mouse for card and button selection. All of the games depicted in these drawings involve player card selection from a displayed deck of playing cards, where after all players in a card selection round have privately selected their card from the deck, each player is dealt a no-value null card when that player either selects a card that is the same as one selected by another player in the current round or is the same as a card dealt to another player in a previous round. Otherwise, the player is dealt his/her selected card. Note that in these drawings a large X on a dealt card indicates that it is a null card. Except when the game is over, the suit or rank of the selected card is not displayed on the null cards dealt to virtual players. Also, all cards in the displayed deck that the actual player knows have already been dealt are shadowed out.

Set one (FIGS. 1A-O) shows fifteen drawings for a card selection game involving an actual player playing against two virtual players. Three community cards are first randomly dealt followed by 4 rounds of player card selection from a deck of playing cards displayed face up. The community cards are usable by all players in forming a hand. Cards are dealt face down in the first card selection round and face up in each of the next three rounds. In these drawings the displayed deck from which the players select cards has fewer cards than a standard 52-card deck of playing cards and contains the community cards, which are not selectable. A card selection game using community cards could also be played with a 52-card deck or some other kind of deck of playing cards for player card selection, with or without the community cards included in the displayed deck.

FIGS. 1A-O are divided into 2 subsets. The first subset FIGS. 1A-I contains nine drawings and represents a first actual player NAME1 playing against 2 virtual players NAME2 and NAME3. The first subset FIGS. 1A-I can be considered alone or in conjunction with the second subset FIG. 1J-O.

FIG. 1A shows NAME1's screen 10 for a single actual player, NAME1 12, playing against two virtual players, NAME2 14 and NAME3 16. Three community cards, diamond six 18, spade queen 20, spade four 22, usable by all players in forming a hand, have been dealt face up. All the players are about to make their first card selection from the same displayed deck 24 that also displays the community cards shadowed out 26 to indicate that they have already been dealt. The club queen 28 in the card selection deck is raised to indicate that NAME1 has clicked on it as his/her current selection choice on this first card selection round. Once NAME1 is sure of his choice, he/she will click on the Confirm button 30 to execute that choice for his/her first card selection. NAME1's current card selection Undo Count of zero is displayed 32.

FIG. 1B shows NAME1's screen 40 at the start of the second card selection round. Since cards are dealt face down in the first card selection round, only NAME1's first dealt card, the club queen 42 is displayed, and both NAME2's first dealt card 44 and NAME3's first dealt card 46 are dealt face down. The club queen is shadowed out in the displayed card selection deck 48 because NAME1 knows it has already been dealt. Now that at least one card has been selected and dealt to each player, NAME1 has the option of canceling the previous card selection round for everyone by clicking on the Undo button 50. The heart queen in the card selection deck is raised 52 to indicate that NAME1 has clicked on it as the current candidate for card selection on this second card selection round.

FIG. 1C shows NAME1's screen 60 at the start of the fourth card selection round. So far, three cards have been dealt to each player. In the second card selection round, NAME1 selected the heart queen, got blocked and was dealt a null card 62, NAME2 selected and was dealt the spade nine 64 and NAME3 got blocked and was dealt a null card 66. In these card selection games, when a round is dealt face up, a player only sees the suit and rank of a card dealt to another player when that player's selection hasn't been blocked. In this instance, NAME3's second card selection was blocked and therefore, NAME1 does not see its suit and rank and neither does NAME2. In the third card selection round, NAME1 selected the diamond queen, got blocked and was dealt a null card 68, NAME2 got blocked and was dealt a null card 70 and NAME3 selected and was dealt the heart four 72. Note that in the card selection deck both the spade nine and heart four are now shadowed out 74. Note also that neither the heart queen nor the diamond queen in the deck is shadowed out 76. Though NAME1 selected each of these cards on a previous round, they were blocked and not dealt to NAME1. Also, NAME1 has no indication that either the heart queen or the diamond queen was dealt to any of the other players. Therefore, either card can be selected again by NAME1 in the current selection round. At this point NAME1 has not cancelled any previously dealt cards, so the Undo Count is still zero 78. NAME1 now decides he/she won't be able to get the best hand with his/her current dealt cards, so NAME1 clicks on the Undo button 80 to cancel the previous third card selection round for all the players.

FIG. 1D shows NAME1's screen 90 at the start of the new third card selection round, after NAME1 just clicked on the Undo button in the fourth card selection round to cancel the cards dealt to the players in the third card selection round. Note the changes that have just taken place. The Undo Count 92 has been incremented and is now 1. Each player is back to only having two cards dealt to him or her, which are the same as they were prior to the card selection undo. For NAME1 the first dealt card is the club queen 96 and the second dealt card is the blocked heart queen 102. For NAME2 the first dealt card is face down 98 and the second dealt card is the spade nine 104. For NAME3 the first dealt card is face down 100 and the second dealt card is a null card 106. As a result of the cancellation, the heart four in the card selection deck 94 is no longer shadowed out for it no longer has been dealt to NAME3 and is therefore free to be selected. NAME1 still thinks he/she won't be able to get the best hand with his/her current dealt cards, so NAME1 clicks on the Undo button 108 to cancel the second card selection round for all the players.

FIG. 1E shows NAME1's screen 110 at the start of the second card selection round, after NAME1 just clicked on the Undo button in the third card selection round to cancel the cards dealt to the players in the second card selection round. The Undo Count 112 has been incremented and is now 2. Each player is back to only having one card dealt to him or her, which is the same as it was prior to the card selection undos. For NAME1 the first dealt card is the club queen 118. For NAME2 the first dealt card is face down 120. For NAME3 the first dealt card is face down 122. As a result of the cancellation, the spade nine is no longer shadowed out 114 in the card selection deck for it no longer has been dealt to NAME2 and is therefore free to be selected. The diamond queen in the card selection deck is raised 116 to indicate that NAME1 has clicked on it as his/her current card choice on this second card selection round. NAME1 then clicks on the Confirm button 128 to execute that choice for his/her second card selection.

FIG. 1F shows NAME1's screen 130 at the start of the third card selection round, after all the players privately selected and then were dealt their second card. This time in the second card selection round, NAME1 selected and was dealt the diamond queen 132, NAME2 selected and was dealt the spade nine 134 and NAME3 selected and was dealt the heart queen 136. Consequently, the diamond queen, spade nine and heart queen are all shadowed out in the card selection deck 138. The club four in the card selection deck is raised 140 to indicate that NAME1 has clicked on it as his/her current card choice on this third card selection round. NAME1 then clicks on the Confirm button 142 to execute that choice for his/her third card selection.

FIG. 1G shows NAME1's screen 150 at the start of the fourth card selection round, after all the players privately selected and then were dealt their third card. This time in the third card selection round NAME1 selected the club four, got blocked and was dealt a null card 152, NAME2 got blocked and was dealt a null card 154 and NAME3 got blocked and was dealt a null card 156. Though NAME1's third card selection of the club four was blocked 152, it still can be selected again in this current fourth round since it might not have been dealt previously. NAME1 decides to pick the club four 158 again and then clicks on the Confirm button 160 to execute that choice for his/her fourth card selection.

FIG. 1H shows NAME1's screen 170 at the start of the fourth card selection round, after it was determined that NAME1's previous fourth round card selection of the club four 172 did not produce the best hand. Since the previous card selection was made on the final card selection round, NAME1 is informed that he/she did not have the best hand 174. Since the goal of the game is for NAME1 to get the best hand with the fewest number of Undos, the cards dealt to the players in the previous fourth card selection round are canceled, the Undo Count 176 is incremented to 3 and play reverts again to the start of the fourth card selection round. NAME1 now selects the heart four 178 and then clicks on the Confirm button 180 to execute that choice for his/her fourth card selection.

FIG. 1I shows NAME1's screen 190 when the game is over. It displays the suit and rank of every card selected by each player on every card selection round, regardless of whether the associated dealt card was dealt face down or was a null card. In the first card selection round, NAME2 selected and was dealt the spade seven 196 and NAME3 selected and was dealt the club four 204. In the third round, NAME2 selected the heart four, got blocked and was dealt the null card 198 and NAME3 also selected the heart four, also got blocked and was dealt the null card 206. In the fourth and final round, NAME1 selected and was dealt the heart four 192 to give NAME1 a full house 194, NAME2 selected and was dealt the spade five 200 to give NAME2 a spade flush 202 and NAME3 selected the club queen but got blocked and was dealt the null card 208 to give NAME3 two pair 210. NAME1 has the best hand 212 and a final Undo Count of three 214.

The second subset FIGS. 1J-O contains six screen drawings of a second actual player playing the same game against two virtual players, which was played by the first actual player. Taken together with FIGS. 1A-I they represents 2 actual players, NAME1 and NAME4 indirectly playing against each other in a tournament. The tournament winner is the actual player who uses card selection undo the fewest number of times in building the best hand directly playing against his/her respective virtual players.

FIG. 1J shows NAME4's screen 310 at the start of the same game played by NAME1. It shows a single actual player, NAME4 312, playing against two virtual players, NAME5 314 and NAME6 316. The same three community cards, diamond six 318, spade queen 320, spade four 322, have been dealt face up. They are the same community cards dealt in FIG. 1A (18, 20, 22). All the players are about to make their first card selection from the displayed deck 324 that also displays the community cards shadowed out 326 and has the same composition as the displayed deck 24 in FIG. 1A. The Undo Count is zero 332. NAME4 has selected the club four 328 and confirmed it by clicking on the Confirm button 330.

FIG. 1K shows NAME4's screen 340 at the start of the third card selection round. So far, two cards have been dealt to each player. In the first card selection round, NAME4 selected the club four, got blocked and was dealt a null card 344, NAME5's card was dealt face down 346 and NAME6's card was dealt face down 348. In the second card selection round, NAME4 selected the heart queen, got blocked and was dealt a null card 350, NAME5 selected and was dealt the spade nine 352 and NAME6 got blocked and was dealt a null card 354. The spade nine is now shadowed out 356 in the card selection deck. At this point NAME4 has not cancelled any previously dealt cards, so the Undo Count is still zero 342. However, NAME4 decides he/she won't be able to get the best hand with his/her current dealt cards, so NAME4 clicks on the Undo button 358 to cancel the previous second card selection round.

FIG. 1L shows NAME4's screen 370 at the start of the first card selection round, after NAME4 clicked on the Undo button in the third card selection round and then immediately again in the second card selection round. The Undo Count is now two 372 at the new start of the first card selection round. NAME4 has now selected the club queen 374 as his/her new first card selection and confirmed it by clicking on the Confirm button 376.

FIG. 1M shows NAME4's screen 380 after four rounds of card selection. It displays the suit and rank of every card selected by each player on every card selection round, regardless of whether the associated dealt card was dealt face down or was a null card. NAME4 selected and was dealt the heart four in the fourth card selection round 384 to give him/her a full house 386. NAME5 selected and was dealt the spade seven in the first card selection round 388 and selected and was dealt the spade five in the fourth card selection round 390 to give him/her a spade flush 392. NAME6 selected and was dealt the club four in the first card selection round 394. NAME6 ends up with two pair 396. NAME4 has the best hand 398 and a final Undo Count of two 382.

For the same community cards and the same card selection deck, FIG. 1I shows that actual player NAME1, with a card selection Undo Count of three 214, has gotten the best hand 212 playing against virtual players NAME2 and NAME3, and FIG. 1M shows that actual player NAME4, with a card selection Undo Count of two 382, has gotten the best hand 798 playing against virtual players NAME5 and NAME6.

FIG. 1N shows NAME1's screen 400 at the end of the tournament between actual players NAME1 and NAME4 playing the same game against their respective virtual players. The tournament winner is the actual player, NAME1 or NAME4 who has used Undo Count the fewest number of times to build the best hand. It shows that NAME4 is the winner with the smallest Undo Count of 2 and displays the Undo Count of each actual player 402.

FIG. 1O shows NAME4's screen 410 at the end of the tournament. It shows that NAME4 is the winner with the smallest Undo Count of 2 and displays the Undo Count of each actual player 412.

Set two (FIGS. 2A-F) shows 6 screen drawings for a card selection game, with no community cards, involving one actual player playing against one virtual player. There are 6 rounds of player card selection with the first round dealt face down and the next five rounds dealt face up. In the first round, players select from a standard 52-card first deck of playing cards, and in rounds two thru six, from a smaller second deck of cards. The second deck is composed of cards selected in the first round and cards randomly selected from the first deck. Card selection undo only applies to the second deck and can only be used to cancel cards dealt to the players in rounds 2 thru 6.

FIG. 2A shows NAME1's screen 510 for a single actual player, NAME1 512, playing against one virtual player, NAME2 514. Both players are about to make their first card selection from the standard 52-card first deck of playing cards displayed face up 516. The diamond ace 518 in the card selection deck is raised to indicate that NAME1 has clicked on it as his/her current selection choice on this first selection round. Once NAME1 is sure of his choice, NAME1 will click on the Confirm button 520 to execute that choice.

FIG. 2B shows NAME1's screen 530 at the start of the second card selection round. The smaller second deck of cards is displayed face up 536. It is composed of the two cards selected on the first round plus sixteen other cards randomly selected from the first deck of cards. In the first card selection round, NAME1 selected and was dealt the diamond ace 532 and NAME2 was dealt a card face down 534. The diamond ace is shadowed out 538 in the second card selection deck, since NAME1 knows that it has already been dealt. NAME1's current card selection Undo Count of zero is displayed 540. The spade ace in the card selection deck is raised 542 to indicate that NAME1 has clicked on it as his/her current card choice on this second card selection round. NAME1 then clicks on the Confirm button 544 to execute that choice.

FIG. 2C shows NAME1's screen 550 at the start of the fifth card selection round. So far, four cards have been dealt to each player. In the second card selection round, NAME1 selected and was dealt the spade ace 552 and NAME2 selected and was dealt the heart ten 554. In the third card selection round, NAME1 selected and was dealt the club ace 556 and NAME2 selected and was dealt the heart eight 558. In the fourth card selection round, NAME1 selected and was dealt the diamond ten 560 and NAME2 selected and was dealt the heart jack 562. The cards that NAME1 knows have been dealt are shadowed out 564 in the card selection deck. The Undo button is displayed 568 and has been displayed starting in the third card selection round. The heart nine in the card selection deck is raised 566 to indicate that NAME1 has clicked on it as his/her current card choice on this fifth card selection round. NAME1 then clicks on the Confirm button 570 to execute that choice for his/her fifth dealt card.

FIG. 2D shows NAME1's screen 580 at the start of the sixth card selection round. In the fifth card selection round, NAME1 selected the heart nine, got blocked and was dealt a null card 582 and NAME2 also got blocked and was dealt a null card 584. The spade ten in the card selection deck is raised 586 to indicate that NAME1 has clicked on it as his/her current card choice on this sixth and final card selection round. NAME1 then clicks on the Confirm button 588 to execute that choice for his/her sixth dealt card.

FIG. 2E shows NAME1's screen 590 at the start of the sixth card selection round, after it was determined that NAME1's previous card selection of the spade ten did not produce the best hand. Since the previous card selection was made on the final card selection round, NAME1 is informed that he/she did not have the best hand 592. Since the goal of the game is for NAME1 to get the best hand with the fewest number of Undos, the cards dealt to the players in the previous sixth card selection round are canceled, the Undo Count 594 is incremented to 1 and play reverts again to the start of the sixth card selection round. The spade ten in the card selection deck is no longer shadowed out 596. The heart nine is now raised 598 to indicate that NAME1 has clicked on it as his/her new current card choice on this sixth and final card selection round. NAME1 then clicks on the Confirm button 600 to execute that choice for his/her sixth dealt card.

FIG. 2F shows NAME1's screen 610 when the game is over. It displays the suit and rank of every card selected by each player on every card selection round, regardless of whether the associated dealt card was dealt face down or was a null card. In the first card selection round, NAME2 selected and was dealt the heart queen 612. In the fifth card selection round, NAME2 selected the heart nine, got blocked and was dealt the null card 614. In the sixth and final round, NAME1 selected the heart nine again, but again got blocked and was dealt a null card 616, and NAME2 selected the heart nine again, but again got blocked and was dealt a null card 618. This gave NAME1 a final hand of three of a kind 620 and NAME2 a final hand of only queen high 622. As a result, NAME1 has the best hand 624 and a final Undo Count of one 626.

Set three (FIGS. 3A-G) shows 7 screen drawings for a card selection game, with no community cards, involving one actual player playing against one virtual player. There are 6 rounds of player card selection with the first round dealt face down and the next five rounds dealt face up. In every round, players select from the same deck of playing cards. Set three (FIGS. 3A-G) differs from set two (FIGS. 2A-F) in that only one deck of playing cards is used for card selection in set three and card selection undo can be used to cancel cards dealt to the players in any of the rounds 1 thru 6.

FIG. 3A shows NAME1's screen 710 for a single actual player, NAME1 712, playing against one virtual player, NAME2 714. Both players are about to make their first card selection from the same deck of playing cards displayed face up 716. The diamond ace 720 in the card selection deck is raised to indicate that NAME1 has clicked on it as his/her current choice on this first card selection round. Once NAME1 is sure of his choice, he/she will click on the Confirm button 722 to execute that choice for his/her first card selection. NAME1's current card selection Undo Count of zero is displayed 718.

FIG. 3B shows NAME1's screen 730 at the start of the fifth card selection round. In the first card selection round, NAME1 selected and was dealt the diamond ace 732 and NAME2 was dealt a card face down 734. In the second card selection round, NAME1 selected and was dealt the spade ace 736 and NAME2 selected and was dealt the heart ten 738. In the third card selection round, NAME1 selected and was dealt the club ace 740 and NAME2 selected and was dealt the heart eight 742. In the fourth card selection round, NAME1 selected and was dealt the diamond ten 744 and NAME2 selected and was dealt the heart jack 746. All the cards that NAME1 knows have been dealt are shadowed out 748 in the card selection deck. The Undo button is displayed 750 and has been so displayed starting in the second card selection round. The spade ten in the card selection deck is raised 752 to indicate that NAME1 has clicked on it as his/her current card choice on this fifth card selection round. NAME1 then clicks on the Confirm button 754 to execute that choice for his/her fifth dealt card.

FIG. 3C shows NAME1's screen 758 at the start of the sixth card selection round. In the fifth card selection round, NAME1 selected and was dealt the spade ten 760 and NAME2 selected and was dealt the heart nine 762. The spade ten and heart nine are now shadowed out 764 in the card selection deck. NAME1 tries to stop NAME2 from getting a straight flush by clicking on the heart queen in the card selection deck 766 as his/her current card choice and then clicking on the Confirm button 768 to execute that choice for his/her sixth dealt card.

FIG. 3D shows NAME1's screen 770 at the start of the sixth card selection round again after it was determined that NAME1's previous card selection of the heart queen did not produce the best hand. Since the previous card selection was made on the final card selection round, NAME1 is informed that he/she did not have the best hand 772. Since the goal of the game is for NAME1 to get the best hand with the fewest number of Undos, the cards dealt to the players in the previous sixth card selection round are canceled, the Undo Count 774 is incremented to 1 and play reverts again to the start of the sixth card selection round. NAME1 decides that he/she won't be able to get the best hand with his/her current dealt cards, so NAME1 clicks on the Undo button 778 to cancel the fifth card selection round for all the players.

FIG. 3E shows NAME1's screen 780 at the start of the fifth card selection round, after NAME1 just clicked on the Undo button in the sixth card selection round to cancel the cards dealt to the players in the fifth card selection round. The Undo Count 782 has been incremented and is now 2. Each player is back to only having four cards dealt to them. As a result of the cancellation, the spade ten 784 and heart nine 786 are no longer shadowed out in the card selection deck. The heart nine in the card selection deck is raised 786 to indicate that NAME1 has clicked on it as his/her current card choice on this fifth card selection round. NAME1 then clicks on the Confirm button 788 to execute that choice for his/her fifth dealt card.

FIG. 3F shows NAME1's screen 790 at the start of the sixth card selection round, after all the players privately selected and then were dealt their fifth card. In the fifth card selection round, NAME1 selected the heart nine, got blocked and was dealt a null card 792 and NAME2 also got blocked and was dealt a null card 794. To try to block NAME2 from getting a straight flush, NAME1 has selected the heart nine again 796 and confirmed that choice as his/her sixth card selection by clicking on the Confirm button 798.

FIG. 3G shows NAME1's screen 800 when the game is over. It displays the suit and rank of every card selected by each player on every card selection round, regardless of whether the associated dealt card was dealt face down or was a null card. In the first card selection round, NAME2 selected and was dealt the heart queen 802. In the fifth card selection round, NAME2 selected the heart nine, got blocked and was dealt the null card 804. In the sixth and final round, NAME1 selected the heart nine again, got blocked and was dealt a null card 806 and NAME2 selected the heart nine again but also got blocked and was dealt a null card 808. This gave NAME1 a final hand of three of a kind 810 and NAME2 a final hand of only queen high 812. As a result, NAME1 has the best hand 814 with final Undo Count of two 816.

In all of these embodiments, if the actual player selects a card from the deck on the final round of the game that does not result in a winning hand for the actual player, then the round is automatically cancelled and the card dealt to each player on that round is removed from that player's hand. In this situation, the card dealt to the actual player need not be displayed as transferred to the actual player's hand, but is considered to temporarily form part of the actual player's hand until the automatic cancellation of the round is completed. Similarly, in this situation, the card dealt to each virtual player need not be shown being transferred to that virtual player's hand and is considered to temporarily form part of that virtual player's hand until the automatic cancellation of the round is completed.

While particular embodiments of the present invention have been shown and described, it will be obvious to those skilled in the art that changes and modifications may be made without departing from this invention in its broader aspects and, therefore, any subsequent claims may encompass within their scope all changes and modifications that fall within the true spirit and scope of the invention.

What is claimed is:

1. A method for playing a card game on a computing device having a display screen (10), the computing device being programmed to carry out the card game using card representations stored in a memory, the program enabling an actual player to play the card game against at least one virtual player controlled by the computing device, a player remaining in the game being defined as an active player, the game consisting of a series of player card selection rounds, where on each such round each active player selects a card, then after all the active players have made their card selection each active player is dealt a card, where at the end of some of these rounds, the actual player may choose to cancel or undo that round and have the card dealt to each active player in that round removed from that player's hand, the game being over when each active player's hand contains a predetermined number of cards and the actual player has the best hand of cards, according to predetermined rules of play, the method comprising:
a) displaying to the actual player on the display screen (10) one or more randomly dealt community cards (18, 20, 22) from a deck of playing cards, the one or more community cards being usable by all players in forming a card hand, all community cards in the card game being randomly dealt before any cards are dealt to individual players, the deck of playing cards being a representation of a physical deck of cards, the display screen (10) displaying at least a portion of the deck of playing cards (24) face up, the display screen displaying the current count of the number of times a card selection round has been canceled;
b) selecting by the actual player using a computer interface a desired card of a particular rank and suit from the displayed deck of playing cards;
c) selecting by each active, virtual player a card of a particular rank and suit from the displayed deck of playing cards;
d) for each active player, determining if the card selected by that player is the same as a card selected by another player in a current round or the same as a card dealt to another player on a previous round;
e) if a first player chose the same card as another player, as determined in step (d), the first player is dealt a null card that has no value in forming a card hand;
f) if the first player did not choose the same card as another player, as determined in step (d), the first player is dealt the card that the first player selected;
g) if each active player's hand contains the predetermined number of cards and the actual player does not have the best hand of cards, then the last card dealt to each active player is removed from that player's hand and the count of the number of times a card selection round has been canceled is increased by one;
h) if each active player's current hand contains fewer than the predetermined number of cards, then the actual player may choose to have the last dealt card in each active player's hand removed from that player's hand;
i) if the actual player chose to have the last dealt card in each active player's hand removed, then that card is removed from each active player's hand, the count of the number of times a card selection round has been canceled is increased by one and step h is repeated;
j) repeating steps b-i if there is at least one active, virtual player, until each active player's hand contains the predetermined number of cards and the actual player has the best hand of cards; and
k) controlling the display screen (190) to indicate the total number of times a card selection round has been canceled and to identify the actual player as the active player with the best hand of cards, according to predetermined rules of play.

2. The method of claim 1 wherein step (a) comprises:
a) displaying to the actual player on the display screen (10) one or more randomly dealt community cards (18, 20, 22) from a deck of playing cards, the one or more community cards being usable by all players in forming a card hand, all community cards in the card game being randomly dealt before any cards are dealt to individual players, the deck of playing cards being a representation of a physical deck of cards, the display screen (10) displaying at least a portion of the deck of playing cards (24) face up excluding the community cards, the display screen displaying the current count of the number of times a card selection round has been canceled.

3. The method of claim 1 wherein step (d) comprises:
d) for each active player, determining if the card selected by that player is the same as a card selected by another player in a current round or a previous round.

4. The method of claim 2 wherein step (d) comprises:
d) for each active player, determining if the card selected by that player is the same as a card selected by another player in a current round or a previous round.

5. A method for playing a card game on a computing device having a display screen (510), the computing device being programmed to carry out the card game using card representations stored in a memory, the program enabling an actual player to play the card game against at least one virtual player controlled by the computing device, a player remaining in the game being defined as an active player, the game consisting of a series of player card selection rounds, where on each such round each active player selects a card, then after all the active players have made their card selection each active player is dealt a card, where at the end of some of these rounds the actual player may choose to cancel or undo that round and have the card dealt to each active player in that round removed from that player's hand, the game being over when each active player's hand contains a predetermined number of at least two cards and the actual player has the best hand of cards, according to predetermined rules of play, the method comprising:
a) displaying a first deck of playing cards (516), the deck of playing cards being a representation of a physical deck of cards, the display screen (510) displaying the deck of playing cards (516) face up;
b) selecting by the actual player using a computer interface a desired card of a particular rank and suit from the deck in step (a);
c) selecting by each virtual player a card of a particular rank and suit from the deck of playing cards in step (a);
d) for each player, determining if the card selected by that player is the same as a card selected by another player;
e) if a first player chose the same card as another player, as determined in step (d), the first player is dealt a null card that has no value in forming a card hand;
f) if the first player did not choose the same card as another player, as determined in step (d), the first player is dealt the card that the first player selected;
g) displaying a second deck of playing cards (536) face up on the display screen (530), the second deck of playing cards containing all cards selected either in step (b) or in step (c), plus cards randomly selected from the first deck of cards, the second deck of cards containing fewer cards than the first deck of cards, the display screen displaying the current count of the number of times a card selection round has been canceled;
h) selecting by the actual player using a computer interface a desired card of a particular rank and suit from the second deck of playing cards;
i) selecting by each active, virtual player a card of a particular rank and suit from the second deck of playing cards;
j) for each active player, determining if the card selected by that player is the same as a card selected by another player in a current round or the same as a card dealt to another player on a previous round;
k) if a first player chose the same card as another player, as determined in step (j), the first player is dealt a null card that has no value in forming a card hand;
l) if the first player did not choose the same card as another player, as determined in step (j), the first player is dealt the card that the first player selected
m) if each active player's hand contains the predetermined number of cards and the actual player does not have the best hand of cards, then the last card dealt to each active player is removed from that player's hand and the count of the number of times a card selection round has been canceled is increased by one;
n) if each active player's hand contains at least two cards and fewer than the predetermined number of cards, then the actual player may choose to have the last card dealt in each active player's hand removed from that player's hand;
o) if the actual player chose to have the last card dealt in each active player's hand removed, then that card is removed from each active player's hand, the count of the number of times a card selection round has been canceled is increased by one and step n is repeated;
p) repeating steps h-o if there is at least one active, virtual player, until each active player's hand contains the predetermined number of cards and the actual player has the best hand of cards; and
q) controlling the display screen (610) to indicate the total number of times a card selection round has been canceled and to identify the actual player as the active player with the best hand of cards, according to predetermined rules of play.

6. The method of claim 5 wherein step (j) comprises:
j) for each active player, determining if the card selected by that player is the same as a card selected by another player in a current round or a previous round.

7. A method for playing a card game on a computing device having a display screen (710), the computing device being programmed to carry out the card game using card representations stored in a memory, the program enabling an actual player to play the card game against at least one virtual player controlled by the computing device, a player remaining in the game being defined as an active player, the game consisting of a series of player card selection rounds, where on each such round each active player selects a card, then after all the active players have made their card selection each active player is dealt a card, where at the end of some of these rounds the actual player may choose to cancel or undo that round and have the card dealt to each active player in that round removed from that player's hand, the game being over when each active player's hand contains a predetermined number of cards and the actual player has the best hand of cards, according to predetermined rules of play, the method comprising:
a) displaying to the actual player on the display screen (710) a deck of playing cards, the deck of playing cards being a representation of a physical deck of cards, the display screen (710) displaying the deck of playing cards (716) face up, the display screen displaying the current count of the number of times a card selection round has been canceled;
b) selecting by the actual player using a computer interface a desired card of a particular rank and suit from the deck of playing cards in step (a);
c) selecting by each active, virtual player a card of a particular rank and suit from the deck of playing cards in step (a);
d) for each active player, determining if the card selected by that player is the same as a card selected by another player in a current round or the same as a card dealt to another player on a previous round;
e) if a first player chose the same card as another player, as determined in step (d), the first player is dealt a null card that has no value in forming a card hand;
f) if the first player did not choose the same card as another player, as determined in step (d), the first player is dealt the card that the first player selected;
g) if each active player's hand contains the predetermined number of cards and the actual player does not have the best hand of cards, then the last card dealt to each active player is removed from that player's hand and the count of the number of times a card selection round has been canceled is increased by one;
h) if each active player's hand contains fewer than the predetermined number of cards, then the actual player may choose to have the last card dealt in each active player's hand removed from that player's hand;
i) if the actual player chose to have the last card dealt in each active player's hand removed, then that card is removed from each active player's hand, the count of the number of times a card selection round has been canceled is increased by one and step h is repeated;
j) repeating steps b-i if there is at least one active, virtual player, until each active player's hand contains the predetermined number of cards and the actual player has the best hand of cards; and
k) controlling the display screen (800) to indicate the total number of times a card selection round has been canceled and to identify the actual player as the active player with the best hand of cards, according to predetermined rules of play.

8. The method of claim 7 wherein step (d) comprises:
d) for each active player, determining if the card selected by that player is the same as a card selected by another player in a current round or a previous round.
